(19) United States
(12) Patent Application Publication
(10) Pub. No.: US 2009/0052453 A1
(43) Pub. Date: Feb. 26, 2009

(54) Method and apparatus for improving the performance of voice over IP (VoIP) speech communications systems which use robust header compression (RoHC) techniques

(76) Inventors: Minkyu Lee, Ringoes, NJ (US); James William McGowan, Flemington, NJ (US); Yang Yang, Morris Plains, NJ (US)

Correspondence Address: Lucent Technologies Inc.;Docket Administrator, Room 2F-192, 600 Mountain Avenue, Murray Hill, NJ, 07974-0636, US

(21) Appl. No.: 11/894,929

(22) Filed: Aug. 22, 2007

(51) Int. Cl. H04L 12/56

(52) U.S. Cl. 370/392; 370/394; 370/474; 370/477

(57) ABSTRACT

A method and apparatus for use in improving the performance of Voice over Internet Protocol (VoIP) communication systems which use Robust Header Compression (RoHC) techniques for reducing communications protocol overhead. Specifically, having recognized that in VoIP applications (unlike, for example, data services applications), severely late packets cannot be used, a “RoHC-Guard” filters out packets that are very late, making it impossible for RoHC to perform the costly and unnecessary re-sync. In accordance with one embodiment of the invention, a RoHC-Guard module, operating as a pre-filter to a RoHC module, saves, rather than merely discards, late packets. Then, if a predetermined number of such packets are consecutively received, they are provided to RoHC module.

### FIELD OF THE INVENTION

The present invention relates generally to the field of VoIP (Voice over Internet Protocol) speech communication systems and more particularly to a method and apparatus for improving the performance of VoIP systems which use Robust Header Compression (RoHC) techniques.

### BACKGROUND OF THE INVENTION

Voice, video and data over IP networks each require that all information traversing the network be sent using a hierarchy of communication protocols, such as, for example, IP, UDP and RTP, each of which is fully familiar to those of ordinary skill in the art. Each of these protocols adds headers and/or footers, resulting in relatively large amounts of overhead (in comparison to the amount of actual data being transmitted across the network). For wireless voice communication applications in particular, this overhead is typically several times the bandwidth of the voice data itself.

Robust Header Compression (RoHC), a technique familiar to those skilled in the art, is often used, inter alia, over the links of a network connection path to reduce the total bandwidth required for the RTP, UDP and IP communication protocol layers. Typically, when used in wireless VoIP systems, RoHC reduces the total bandwidth from approximately 40 bytes per data packet to an average of 1-2 bytes per packet. This compression is based upon typical regularities which are found in the packet headers. For example, in accordance with the RTP communications protocol, each packet is assigned a 32-bit packet number in sequential order, and this packet number is included in the packet header information. However, just as one can express the four digit year 1999 in many contexts by using only the two digit number 99, RoHC compresses RTP packet numbers in a similar fashion by using only the least significant “digits” (i.e., the least significant bits) of the packet number. In most cases, this is adequate, since the packet numbers are generally increasing sequentially.

However, this “abbreviation” creates a situation similar to the infamous Y2K problem. That is, if a year is given in the abbreviated 2 digit form as 04, does this mean the year 2004 or the year 1904? Without any context, one cannot tell for sure. One common solution to the Y2K problem was to make the assumption that all two digit numbers 50 and higher start with the digits 19, while all two digit numbers lower than 50 start with the digits 20. In other words, the year is simply assumed to be within the range from 1950 through 2049 when only 2 digits have been used to represent it. Then, over time, this window can slide forward, so that eventually the range might be 1960 through 2059, and then 1970 through 2069, etc.

In the case of RoHC, since greater compression is obtained by using a relatively small window, only a few bits are typically used to code the RTP packet number. And as described above, this window slides upward as the sequence of RTP headers, and thus the packet numbers, progresses forward. However, this approach may create a difficulty when out-of-order packets are received—a situation that occurs from time to time as a result, inter alia, of network routing delays. Recall that in the Y2K example where only two digits are used to represent a four digit year, the range limit (i.e., the window) is 100 years. Thus, for example, it is not possible to represent the year 1950 in two digits once the window has moved upward to accommodate the year 2050. In accordance with conventional RoHC techniques, however, when such an event occurs (i.e., when an out-of-order packet whose packet number is outside of the current window is received), a “reset” is triggered (i.e., a “re-sync” is performed), wherein the two sides of the communication link “re-negotiate” (i.e., re-define) the sliding window. In this manner, the newly received packet's number can be properly represented by the abbreviated version thereof.

Unfortunately, however, when RoHC is being used in a VoIP application, such a re-sync often causes a call in progress to be disrupted. In particular, the re-sync may create an unacceptably long gap in the speech heard by the listener, due to the fact that significant additional bandwidth is required. On the other hand, the alternative approach of simply using more bits to encode (i.e., abbreviate) the packet number, thereby providing a larger range, results in a far less efficient use of bandwidth for each and every packet, even though it will reduce the total number of re-syncs that occur.

### SUMMARY OF THE INVENTION

The present invention makes advantageous use of the inventors' recognition of the fact that, in voice services applications (unlike, for example, in data services applications), severely late packets cannot typically be used at all. Whereas “slightly” late packets can be used, those packets which arrive after temporally subsequent packets have already been played to the listener (at the receiver) cannot be used. In fact, playing the sound represented by the voice data from such severely late packets invariably causes greater quality degradation than discarding the packet altogether. As such, when a VoIP communication system is using conventional RoHC, a packet which is very late would normally trigger a RoHC re-sync, but then, following this costly re-sync, the packet is quite likely to be discarded at the receiver as being too “old” to be used anyway.

Therefore, in accordance with the principles of the present invention, a novel method and apparatus provides for a “RoHC-Guard” that filters out packets that are very late (e.g., those that would require a re-sync), advantageously making it impossible for RoHC to perform the costly re-sync (since it is likely to be an unnecessary waste of time to do so). In accordance with certain illustrative embodiments of the present invention, a RoHC-Guard module may be advantageously implemented as a pre-filter to a RoHC module, and thereby does not require any changes to be made to the RoHC standard or to existing RoHC implementations. More specifically, in accordance with a first illustrative embodiment of the present invention, packets are monitored to determine if they would cause a re-sync by the RoHC module. If they would cause such a re-sync, they are simply discarded.

In accordance with another illustrative embodiment of the present invention, a RoHC-Guard module, operating as a pre-filter, saves, rather than simply drops, late packets (i.e., those that would require a re-sync). Then, if a predetermined number of such packets are consecutively received (and saved), they are all advantageously provided to RoHC module. This establishes an advantageous safety mechanism which allows “necessary” re-syncs to be performed when the saved packets represent a legitimate, albeit unexpected, change in, for example, RTP sequence numbers.

### BRIEF DESCRIPTION OF THE DRAWINGS

FIG. 1 shows an illustrative VoIP communication system which uses a RoHC compression technique and which includes an apparatus for improving the performance thereof in accordance with certain illustrative embodiments of the present invention.

FIG. 2 shows a flowchart of a method for use in improving the performance of VoIP communication systems which use RoHC compression techniques in accordance with a first illustrative embodiment of the present invention.

FIG. 3 shows a flowchart of a method for use in improving the performance of VoIP communication systems which use RoHC compression techniques in accordance with a second illustrative embodiment of the present invention.

### DETAILED DESCRIPTION OF THE PREFERRED EMBODIMENTS

We will refer to the methods and apparatuses in accordance with various illustrative embodiments of the present invention as RoHC-G (an abbreviation of RoHC-Guard) methods and apparatuses.

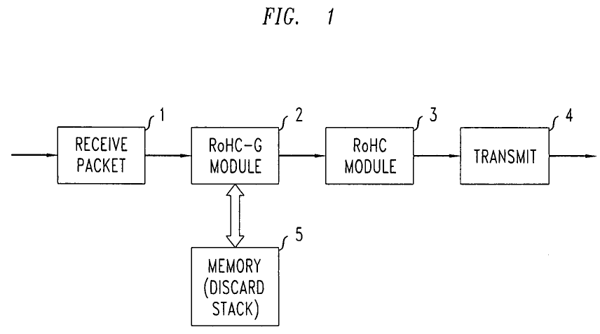

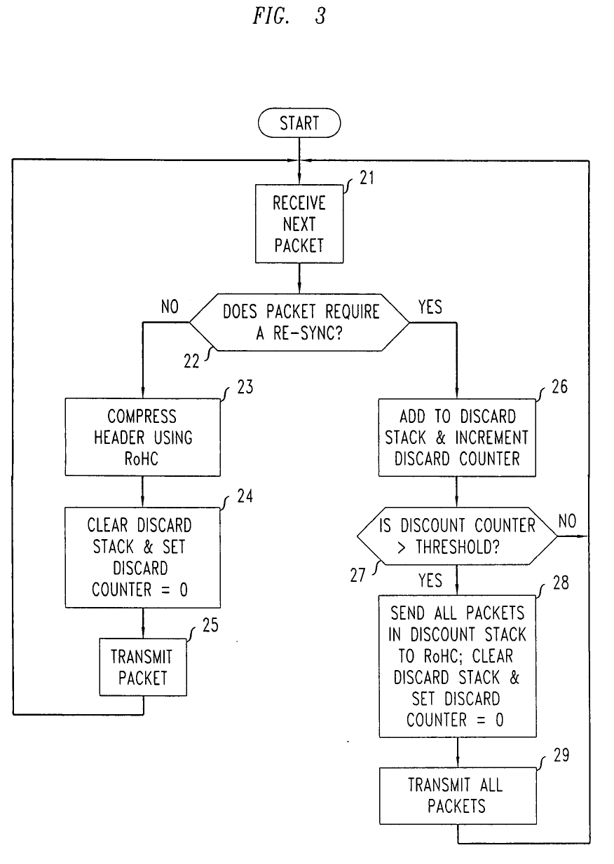

FIG. 1 shows an illustrative VoIP communication system which uses a RoHC compression technique and which includes a RoHC-G module for improving the performance thereof in accordance with certain illustrative embodiments of the present invention. The illustrative system comprises conventional packet receiving module 1, conventional RoHC module 3, and conventional transmitter 4, but is advantageously enhanced with the inclusion of RoHC-G module 2, whose operation precedes that of RoHC module 3 (with respect to a given voice packet). In particular, RoHC-G module 2 advantageously operates as a pre-filter to RoHC module 3, and advantageously filters out packets that would require a re-sync to be performed, thereby preventing such late packets from being seen and processed by RoHC module 3. In addition, in accordance with some illustrative embodiments of the present invention, RoHC-G module 2 uses memory 5, which may comprise a “discard stack,” to store filtered out packets for possible later use. (See the description of the second illustrative embodiment of the present invention, as shown, for example, in FIG. 3, below.)

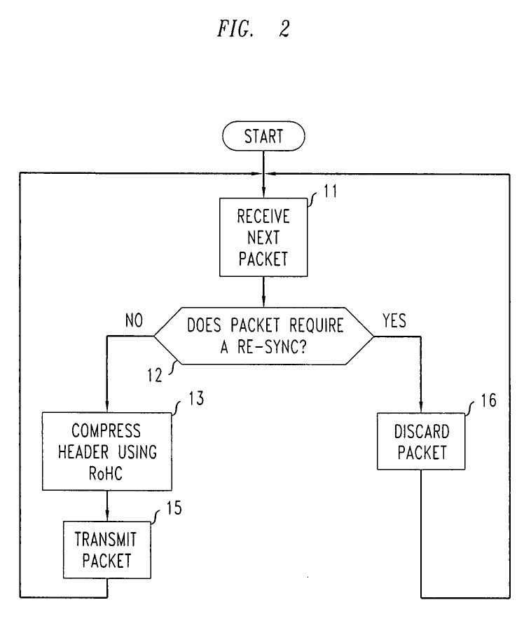

FIG. 2 shows a flowchart of a RoHC-G method in accordance with a first illustrative embodiment of the present invention. In accordance with the illustrative embodiments of the present invention described herein, packets may include RTP, UDP and IP layers, as is contemplated by conventional RoHC techniques. It is these layers that RoHC advantageously compresses by first synchronizing information over a communications link, and then having the sender transmit only the relevant updated information between consecutive headers. In accordance with conventional implementations of RoHC, if the sender is unable to do so because of a substantially out-of-order packet, a re-sync is required.

In accordance with the principles of the present invention, however, once the initial synchronization has been established, the illustrative RoHC-G method of FIG. 2 may be advantageously put into effect. In particular, after a packet is received at block 11, decision block 12 identifies whether the packet would require a re-sync. If it would, then the packet is simply discarded at block 16, and flow returns to block 11 to process the next received packet. If it would not require a re-sync, the packet header is compressed at block 13 using conventional RoHC techniques, and the packet (with the compressed header) is transmitted across the communications link at block 15. Flow then returns to block 11 to process the next received packet.

FIG. 3 shows a flowchart of a RoHC-G method in accordance with a second illustrative embodiment of the present invention. In accordance with this second illustrative embodiment, after a packet is received at block 21, decision block 22 identifies whether the packet would require a re-sync. If it would, then rather than being simply discarded (as in the case of the first illustrative embodiment shown in FIG. 2), the packet is stored in (i.e., added to) to a “discard stack” and a “discard counter” is incremented, both at block 26. (The discard stack may, for example, be implemented with use of a conventional memory.) Decision block 27 then compares the value of the discard counter to a predetermined threshold, which may, for example, be illustratively set equal to three (3).

If the discard counter is greater than the predetermined threshold (e.g., 3), all of the packets which have been stored (i.e., saved) in the discard stack are processed by the conventional RoHC technique (even though doing so will likely require at least one re-sync), and the discard stack is cleared (i.e., emptied) and the discard counter is set equal to zero, all at block 28. All of the resultant header-compressed packets are then transmitted across the communications link at block 29, and flow returns to block 11 to process the next received packet.

If, on the other hand, the packet would not require a re-sync, it is processed by the conventional RoHC technique (i.e., the header is compressed) at block 23. Then, the discard stack is cleared and the discard counter is set equal to zero at block 24. Finally, the header-compressed packet is transmitted at block 25.

Note that, in accordance with the illustrative embodiment of the present invention shown in FIG. 3, the situation in which a re-sync is legitimately required for communication to continue is advantageously accommodated with use of the discard stack. In particular, the illustrative RoHC-G method of FIG. 3 will advantageously block occasional errant packets, but will nonetheless advantageously allow a re-sync to occur when necessary if the out of sequence (and thus initially discarded) packets represent a legitimate, albeit unexpected, change in RTP sequence numbers (for example). As a result, this RoHC-G method in accordance with the second illustrative embodiment of the present invention modestly increases the negative impact of a necessary re-sync, but nonetheless reduces the total number of re-syncs dramatically.

### ADDENDUM TO THE DETAILED DESCRIPTION

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

What is claimed is:

1. A method for performing VoIP communications using a RoHC header-compression technique, the method comprising the steps of:
receiving a given voice packet comprised in a continuous sequence of voice packets, each of the voice packets in said continuous sequence of voice packets having a corresponding header;
removing the given voice packet from the continuous sequence of voice packets if applying the RoHC header-compression technique to the given voice packet in said sequence would result in a re-sync being performed;
applying the RoHC header-compression technique to the given voice packet to produce a corresponding header-compressed voice packet if the given voice packet has not been removed from the sequence of voice packets; and
repeating said steps of receiving, removing and applying a number of times in order to process, as the given voice packet, a corresponding number of successive voice packets in said continuous sequence of voice packets.

2. The method of claim 1 further comprising the step of transmitting the header-compressed voice packet corresponding to the given voice packet if the given voice packet has not been removed from the sequence of voice packets, and wherein the step of repeating said steps of receiving, removing and applying a number of times further comprises repeating the step of transmitting said number of times.

3. The method of claim 1 wherein said corresponding headers of said voice packets in said continuous sequence of voice packets comprise RTP sequence numbers.

4. The method of claim 3 wherein the RoHC header-compression technique comprises compressing the header of the given voice packet by representing the RTP sequence number comprised therein with use of a set of least significant bits thereof.

5. The method of claim 1 wherein the step of removing the given voice packet from the continuous sequence of voice packets if applying the RoHC header-compression technique to the given voice packet in said sequence would result in a re-sync being performed comprises discarding the given voice packet if applying the RoHC header-compression technique to the given voice packet in said sequence would result in a re-sync being performed.

6. The method of claim 1 wherein the step of removing the given voice packet from the continuous sequence of voice packets if applying the RoHC header-compression technique to the given voice packet in said sequence would result in a re-sync being performed comprises storing the given voice packet in a memory for possible later use if applying the RoHC header-compression technique to the given voice packet in said sequence would result in a re-sync being performed.

7. The method of claim 6 further comprising the steps of:
determining a number of voice packets which are stored in the memory;
comparing the number of voice packets which are stored in the memory to a predetermined threshold;
applying the RoHC header-compression technique to each of the voice packets which are stored in the memory to produce corresponding header-compressed voice packets if the number of voice packets which are stored in the memory exceeds the predetermined threshold; and
clearing the memory of the voice packets stored therein.

8. The method of claim 7 further comprising the step of transmitting each of the header-compressed voice packets corresponding to the voice packets which are stored in the memory if the number of voice packets which are stored in the memory exceeds the predetermined threshold.

9. The method of claim 7 further comprising the step of clearing the memory of any voice packets stored therein, without applying the RoHC header-compression technique thereto, whenever a given voice packet is not removed from the sequence of voice packets and the RoHC header-compression technique is applied to the given voice packet.

10. The method of claim 7 wherein the predetermined threshold is equal to three.

11. An apparatus for performing VoIP communications using a RoHC header-compression technique, the apparatus comprising:
a voice packet receiving module which receives a given voice packet comprised in a continuous sequence of voice packets, each of the voice packets in said continuous sequence of voice packets having a corresponding header;
a RoHC-Guard module which removes the given voice packet from the continuous sequence of voice packets if applying the RoHC header-compression technique to the given voice packet in said sequence would result in a re-sync being performed; and
a RoHC module which applies the RoHC header-compression technique to the given voice packet to produce a corresponding header-compressed voice packet if the given voice packet has not been removed from the sequence of voice packets,
wherein the operations of said voice packet receiving module, said RoHC-Guard module and said RoHC module are adapted to be repeated a number of times in order to process, as the given voice packet, a corresponding number of successive voice packets in said continuous sequence of voice packets.

12. The apparatus of claim 11 further comprising a transmitter which transmits the header-compressed voice packet corresponding to the given voice packet if the given voice packet has not been removed from the sequence of voice packets, and wherein the operation of said transmitter is also adapted to be repeated said number of times.

13. The apparatus of claim 11 wherein said corresponding headers of said voice packets in said continuous sequence of voice packets comprise RTP sequence numbers.

14. The apparatus of claim 13 wherein the RoHC module compresses the header of the given voice packet by representing the RTP sequence number comprised therein with use of a set of least significant bits thereof.

15. The apparatus of claim 11 wherein the RoHC-Guard module discards the given voice packet if applying the RoHC header-compression technique to the given voice packet in said sequence would result in a re-sync being performed.

16. The apparatus of claim 11 further comprising a memory, wherein the RoHC-Guard module stores the given voice packet in the memory for possible later use if applying the RoHC header-compression technique to the given voice packet in said sequence would result in a re-sync being performed.

17. The apparatus of claim 16 wherein the RoHC-Guard module determines a number of voice packets which are stored in the memory and applies the RoHC header-compression technique to each of the voice packets which are stored in the memory to produce corresponding header-compressed voice packets and clears the memory of the voice packets stored therein, if the number of voice packets which are stored in the memory exceeds a predetermined threshold.

18. The apparatus of claim 17 further comprising a transmitter which transmits each of the header-compressed voice packets corresponding to the voice packets which are stored in the memory if the number of voice packets which are stored in the memory exceeds the predetermined threshold.

19. The apparatus of claim 17 wherein the RoHC-Guard module clears the memory of any voice packets stored therein, without applying the RoHC header-compression technique thereto, whenever a given voice packet is not removed from the sequence of voice packets and the RoHC header-compression technique is applied to the given voice packet.

20. The apparatus of claim 17 wherein the predetermined threshold is equal to three.
